(19) United States
(12) Patent Application Publication
(10) Pub. No.: US 2009/0054291 A1
(43) Pub. Date: Feb. 26, 2009

(54) Soil Releasing Agent for Fiber

(76) Inventors: Takahiro Osumi, Wakayama (JP); Koji Ohsaki, Wakayama (JP); Kyoko Okada, Wakayama (JP)

Correspondence Address: BIRCH STEWART KOLASCH & BIRCH, PO BOX 747, FALLS CHURCH, VA, 22040-0747, US

(21) Appl. No.: 12/223,721

(22) PCT Filed: Feb. 14, 2007
(86) PCT No.: PCT/JP2007/053124

§ 371 Date: Aug. 7, 2008

(30) Foreign Application Priority Data
Nov. 9, 2006 (JP) 2006-303934
Feb. 14, 2007 (JP) 2006-038948

(51) Int. Cl. C11D 3/37; C08F 120/34

(52) U.S. Cl. 510/299; 526/310; 526/303.1

(57) ABSTRACT

The invention provides a soil releasing agent for fiber, including a polymer having a weight-average molecular weight in a range from 2,000 to 30,000, and containing a structural unit (A) and a structural unit (B) the content of the structural unit (A) in the polymer being 50 to 99 percent by weight, and the content of the structural unit (B) in the polymer being 1 to 50 percent by weight: (A) a structural unit derived from a monomer which has an unsaturated bond and at least one amino group selected from a primary amino group, a secondary amino group and a tertiary amino group; (B) a structural unit derived from a monomer which has an unsaturated bond and at least one hydrophobic group selected from the group consisting of an alkyl or alkenyl group, each having 4 to 22 carbon atoms, being straight, branched or cyclic, an arylalkyl group having 1 to 22 carbon atoms in the alkyl group and an aryl group, and which monomer has no primary to tertiary amino group and then a method for treating fiber is conducted in an aqueous solution which contains the soil release agent and is adjusted to pH 2 to 9.

### FIELD OF THE INVENTION

The present invention relates to a soil releasing agent for fiber products and to a method for treating the fiber products.

### BACKGROUND ART

For easy release of soil components from fibers during laundering, the fibers are preliminarily treated to bring a base material to adsorb onto the fibers, in some cases. That kind of pretreatment on the fibers expects to give higher detergency than that of usual laundering. The base material which gives the effect is commonly called the “soil releasing agent”.

Regarding the soil releasing agent, varieties of base materials have been introduced. For example, a compound composed mainly of terephthalate is provided in U.S. Pat. No. 3,416,952, U.S. Pat. No. 3,557,039 and U.S. Pat. No. 4,795,584.

There are also provided polyamine derivatives (WO-A 97/42285 and JP-A 11-508319), chitosan derivatives (JP-A 2004-175882), and amine cross-linked compounds (JP-A 2004-197241).

Furthermore, JP-A 11-505568 describes a soil releasing agent containing a copolymer in which a cationic group such as quaternary ammonium group and a hydrophobic group are bonded via a hydrophilic chain of polysaccharide, sulfonated polyester, and the like.

### SUMMARY OF THE INVENTION

The present invention provides a soil releasing agent for fiber, including a polymer having a weight-average molecular weight in a range from 2,000 to 30,000, and containing a structural unit (A) and a structural unit (B) the content of the structural unit (A) in the polymer being 50 to 99 percent by weight, and the content of the structural unit (B) in the polymer being 1 to 50 percent by weight:

(A) a structural unit derived from a monomer which has an unsaturated bond and at least one amino group selected from a primary amino group, a secondary amino group and a tertiary amino group;

(B) a structural unit derived from a monomer which has an unsaturated bond and at least one hydrophobic group selected from the group consisting of an alkyl or alkenyl group, each having 4 to 22 carbon atoms, being straight, branched or cyclic, an arylalkyl group having 1 to 22 carbon atoms in the alkyl group and an aryl group, and which monomer has no primary to tertiary amino group.

The invention provides a method for treating fibers in an aqueous solution containing the soil releasing agent and being adjusted to pH 2 to 9.

The invention provides also use of the above shown polymer as a soil releasing agent for fiber.

### DETAILED DESCRIPTION OF THE INVENTION

Soil releasing agents of U.S. Pat. No. 3,416,952, U.S. Pat. No. 3,557,039 and U.S. Pat. No. 4,795,584, however, fail to attain sufficient effect to fibers of relatively high hydrophilic, such as cotton fiber, though it shows strong effect to hydrophobic synthetic fibers such as polyester blended fibers.

Soil releasing agents of WO-A 97/42285, JP-A 11-508319, JP-A2004-175882 and JP-A2004-197241 are, however, subjected to strong effect of varieties of conditions including a surfactant, temperature, mechanical force, quantity of treating fibers, and added amount of base material during the process of treatment for adsorbing the agent onto the fibers and for deterging the fibers by laundering, thus often failing in attaining satisfactory effect in practical applications.

Soil releasing agent of JP-A(T) 11-505568, however, has a structure of bonding functional groups via a hydrophilic chain so that the agent has a limitation of percentage of the functional group, thus the agent has not yet fully satisfied the effect of soil release.

The present invention provides a soil releasing agent which performs stable soil releasing effect for not only to highly hydrophobic fibers such as polyester fiber but also to relatively high hydrophilic fibers such as cotton fiber, independent of various conditions, and to provide a method for treating products of these fibers.

The inventors of the present invention found that, when the functional group of the polymer used in the soil releasing agent is a quaternary salt, the variations of adsorbability on fibers are small under the variations in pH of the laundering liquid, and that the use of primary to tertiary amino group as the functional group significantly varies the adsorbability on the fibers during the deterging step under a high alkali condition and during the rinsing step under a low alkali condition. Thus the inventors of the present invention confirmed that these characteristics provide strong soil releasing property, and have perfected the present invention. Furthermore, the inventors of the present invention found that that type of structure allows containing a large amount of the portions having primary to tertiary amino group in the polymer, thereby providing further excellent soil releasing performance.

The present invention relates to a soil releasing agent which provides fiber products with a good releasing effect of soil or stain, and to a method for treating the fiber products.

The soil releasing agent and the method for treating thereof according to the present invention give strong soil releasing effect not only to fibers having highly hydrophobic property, such as polyester fiber, but also to fibers having relatively high hydrophilic property, such as cotton fiber. The soil releasing effect can be attained stably, independently of various conditions.

### [Structural Unit (A)]

The structural unit (A) according to the present invention is the one derived from a monomer which contains an unsaturated bond and has at least one amino group of from primary to tertiary amino groups, (hereinafter referred to as “the monomer (A)”). If the above amino group is a quaternary ammonium group, the strong effect as obtained in the present invention cannot be achieved.

Applicable monomer (A) includes a (meth)acrylate compound, a (meth) acrylamide compound, a styrene compound, and a diallyl compound, each having amino group. The term “(meth)acryl” referred to herein signifies acryl or methacryl.

Among these monomers, monomers represented by the general formulae (I) to (III) are preferred.

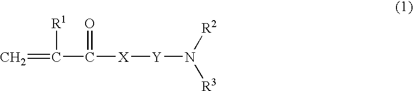

where, R¹ is a hydrogen atom or a methyl group, R² and R³ are the same as or different from each other, and are each a hydrogen atom, an alkyl or alkenyl group having a straight chain or branched chain and containing 1 to 4 carbon atoms, preferably 1 to 3 carbon atoms, or a benzyl group, X is —O— group or —NH— group, and Y is an alkylene group having a straight chain or branched chain containing 1 to 4 carbon atoms.

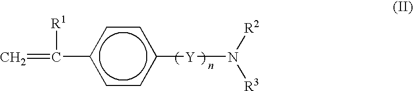

where, R¹, R², R³, and Y are the same as the above, respectively, and n is an integer of 0 or 1.

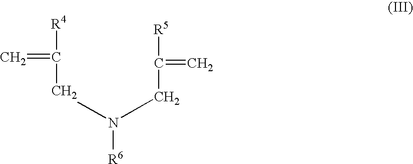

where, R⁴ and R⁵ are the same as or different from each other, and are each a hydrogen atom or a methyl group, and R⁶ is a hydrogen atom, an alkyl or alkenyl group having a straight chain or branched chain and containing 1 to 4 carbon atoms, preferably 1 to 3 carbon atoms, or a benzyl group.

Applicable monomer represented by the general formula (I) includes a (meth)acarylate compound or a (meth) acrylamide compound having dialkylamino group, such as dimethylaminoethyl(meth)acrylate, diethylaminoethyl(meth)acrylate, dipropylaminoethyl(meth)acrylate, diisopropylaminoethyl(meth)acrylate, dibutylaminoethyl(meth)acrylate, diisobutylaminoethyl(meth)acrylate, di-t-butylaminoethyl(meth)acrylate, dimethylaminopropyl(meth)acrylamide, diethylaminopropyl(meth)acrylamide, dipropylaminopropyl(meth)acrylamide, diisopropylaminopropyl(meth)acrylamide, dibutylaminopropyl(meth)acrylamide, diisobutylaminopropyl(meth)acrylamide, and di-t-butylaminopropyl(meth)acrylamide.

Applicable monomer represented by the general formula (II) includes a styrene compound having a dialkylamino group, such as dimethylamino styrene and dimethylaminomethyl styrene. Applicable monomer represented by the general formula (III) includes a diallylamine compound such as diallylmethylamine and diallylamine.

Among these monomers, specifically preferred ones are dimethylaminoethyl(meth)acrylate, diethylaminoethyl(meth)acrylate, dimethylaminopropyl (meth) acrylamide, diallylmethylamine, and diallylamine.

### [Structural Unit (B)]

The structural unit (B) according to the present invention is a unit derived from a monomer which contains an unsaturated bond and has at least one hydrophobic group selected from an alkyl or alkenyl group having 4 to 22 carbon atoms, being straight, branched or cyclic, an arylalkyl group having 1 to 22 carbon atoms in the alkyl group and an aryl group and which monomer has no primary to tertiary amino group, (hereinafter referred to as “the monomer (B)”).

Applicable monomer (B) includes at least one of a (meth)acrylate compound, a (meth)acrylamide compound, a vinyl ester, a vinyl ether, and a styrene compound, having alkyl group, alkenyl group, or arylalkyl group, being straight, branched or cyclic, containing 4 to 22 carbon atoms, preferably 8 to 22 carbon atoms, and more preferably 12 to 22 carbon atoms.

Applicable monomer (B) includes: a (meth)acrylate having an alkyl or alkenyl group being straight, branched or cyclic and containing 4 to 22 carbon atoms, preferably 8 to 22 carbon atoms, such as butyl(meth)acrylate, isobutyl(meth)acrylate, t-butyl(meth)acrylate, cyclohexyl(meth)acrylate, 2-ethylhexyl(meth)acrylate, iso-octyl(meth)acrylate, iso-nonyl(meth)acrylate, lauryl(meth)acrylate, stearyl(meth)acrylate, iso-stearyl(meth)acrylate, behenyl(meth)acrylate, and oleyl(meth)acrylate; a (meth)acrylate having arylalkyl group, such as benzyl(meth)acrylate; a (meth)acrylamide having an alkyl or alkenyl group being straight, branched or cyclic and containing 4 to 22 carbon atoms, preferably 8 to 22 carbon atoms, such as butyl(meth)acrylamide, t-butyl(meth)acrylamide, cyclohexyl(meth)acrylamide, 2-ethylhexyl(meth)acrylamide, lauryl(meth)acrylamide, stearyl(meth)acrylamide, and behenyl(meth)acrylamide; a (meth)acrylamide having an arylalkyl group, such as benzyl(meth)acrylamide; a vinyl ester having an alkyl or alkenyl group being straight, branched or cyclic and containing 4 to 22 carbon atoms, such as vinyl hexanate, vinyl octanate, vinyl decanate, vinyl laurate, vinyl palmitate, and vinyl stearate; a vinyl ether such as butylvinyl ether; and a styrene compound such as styrene, a-methyl styrene, methyl styrene, butyl styrene, t-butyl styrene, and dimethyl styrene.

Among these monomers is preferred a (meth)acrylate compound, a (meth)acrylamide compound or a styrene compound, each having an alkyl or alkenyl group being straight, branched or cyclic and containing 8 to 22 carbon atoms, more preferably 12 to 22 carbon atoms.

For the structural unit (A) and the structural unit (B), one or more of them can be used.

### [Structure of Polymer]

The polymer according to the present invention contains 50 percent by weight or more of the structural unit (A) to the weight of total structural units of the polymer. From the point of adsorption performance, the content thereof is preferably 60 percent by weight or more, and more preferably 70 percent by weight or more. The upper limit of the content thereof is 99 percent by weight, preferably 95 percent by weight, and more preferably 90 percent by weight.

The content of the structural unit (B) is 1 percent by weight or more, preferably 3 percent by weight or more, more preferably 5 percent by weight or more, and even more preferably 10 percent by weight or more. The upper limit of the content thereof is 50 percent by weight, and preferably 45 percent by weight.

The polymer according to the present invention is favorably obtained by copolymerizing the monomer (A) with the monomer (B). Adding to the monomer (A) and the monomer (B), there is applicable copolymerization with a monomer containing an unsaturated bond, and being copolymerizable with the monomer (A) and the monomer (B), (hereinafter referred to as “the monomer (C)”), within a range not adversely affecting the present invention.

Applicable monomer (C) includes: vinyl alcohol; a (meth)acrylate or a (meth)acrylamide, having hydroxyalkyl group containing 1 to 22 carbon atoms, such as hydroxyethyl(meth)acrylate and hydroxypropyl(meth)acrylamide; a (meth)acrylate having polyalkylene (straight chain or branched chain of alkylene group containing 1 to 8 carbon atoms) oxide chain, such as polyethyleneglycol(meth)acrylate, methoxypolyethyleneglycol(meth)acrylate, lauroxypolyethyleneglycol(meth)acrylate (1 to 100 of the degree of polymerization of ethylene glycol), polypropyleneglycol(meth)acrylate (1 to 50 of the degree of polymerization of propylene glycol), and polybutyleneglycol(meth)acrylate (1 to 50 of the degree of polymerization of butylene glycol); a (meth)acrylate of polyhydric alcohol, such as glycerin(meth)acrylate; acrylamide; diacetone(meth)acrylamide; an N-vinyl cyclic amide such as N-vinyl pyrrolidone; N-(meth)acroylmorpholine; vinyl chloride; acrylonitrile; a vinyl compound having carboxylic group, such as (meth)acrylate, maleic acid, itaconic acid, and styrene carboxylate; and a vinyl compound having sulfonic acid group, such as 2-acrylamide-2-methylpropane sulfonate and styrene sulfonate.

The copolymerizing amount of the monomer (C) is preferably in a range from 0 to 49 percent by weight, more preferably from 0 to 40 percent by weight, and even more preferably from 0 to 30percent by weight to the total amount of the monomers.

From the point of easiness in the control of adsorption/desorption to and from fiber, the polymer according to the present invention preferably has a weight average molecular weight in a range from 2,000 to 30,000, and more preferably from 2,000 to 20,000.

The molecular weight distribution of the polymer of the present invention is preferably a narrow one in view of increasing the amount of effectively functioning polymer and further of decreasing the high molecular weight components which hinder the effect of the present invention. When the dispersion ratio [(Weight average molecular weight (Mw))/(Number average molecular weight (Mn))] is adopted as an index of the molecular weight distribution, the value is preferably in a range from 1.0 to 6.0, more preferably from 1.0 to 5.0, and even more preferably from 1.0 to 4.0.

The Mw, Mn, and Mw/Mn of the polymer of the present invention adopt the values determined by Gel Permeation Chromatography (GPC). The eluent is any of water, alcohol, chloroform, dimethylformamide, tetrahydrofuran, acetonitrile, and a combination of them, and the molecular weight is converted to polyethylene oxide or polystyrene.

The polymer structure may be random type, graft type, or block type. Among these, random type and graft type are preferred, and random type is more preferred.

### [Method for Manufacturing Polymer]

The polymer according to the present invention can be prepared by a common polymerization process such as solvent polymerization, suspension polymerization, emulsion polymerization, and dispersion polymerization, applying addition polymerization of the above monomers, such as radical polymerization and ion polymerization. From the point of easiness of synthesis and of adjustability of composition, the radical polymerization is preferred.

The initiator for the radical polymerization may be a common initiator for radical polymerization, such as: a peroxide-based initiator, including lauroyl peroxide, benzoyl peroxide, and ammonium peroxodisulfate; and an azo-based initiator such as 2,2′-azobis(2,4-dimethylvaleronitrile), 2,2-azobis-isobutylonitrile. A preferred use amount of the initiator for radical polymerization is generally in a range from 0.01 to 10 percent by mole, and more preferably from 0.1 to 8 percent by mole to the total amount of monomer, though the amount depends on the kind and concentration of monomer, the kind of initiator, the reaction temperature, and the like.

A method for manufacturing the polymer of the present invention is usually the following. A reactor is charged with the monomer and the polymerization initiator together with a solvent and the like. The dissolved oxygen in the system is removed by replacing the space in the reactor with an inert gas such as nitrogen. Then, the system is heated to 30° C. to 120° C. to conduct polymerization for about 1 to 20 hours. To manufacture a polymer having a narrow molecular weight distribution and having homogeneous monomer composition ratio among polymer molecules, it is preferable that the polymerization be conducted while continuously or intermittently charging the monomer and the polymerization initiator into the reactor which is kept at a specified temperature.

The term “continuously charging” referred to herein has a concept against the concept of charging total amount at a time, or charging in advance, in a reactor. The term “intermittently charging” includes the existence of non-charging time between charging cycles, and means continuously charging in each of pluralities of cycles. The procedure of the polymer preparation is described below in detail referring to an example of solution polymerization.

Monomer and polymerization initiator may be dissolved in a solvent, and be charged to the reactor as a solution. The concentrations of the monomer and the polymerization initiator in the solution is preferably in a range from 20 to 100 percent by weight and in a range from 1 to 100 percent by weight, respectively. The monomer, the polymerization initiator, or their solution may be added to the reactor separately or as a mixture of them. For the case of separate addition, the timing or the rate of addition may be different among them. The adding method of them may be continuously or intermittently.

The timing of addition of them can be arbitrarily selected depending on the kind and concentration of monomer, the kind and amount of polymerization initiator, the kind of solvent, the reaction temperature, and the like. The condition by which the added monomer promptly reacts is preferred, and, from the point of reaction control, a preferable condition is the one to attain the reaction percentage of 50 to 100 percent to all of the added monomer immediately after completing the addition of all monomer. A preferable monomer-adding time is 1 to 20 hours. After completing the addition of monomer, solely the polymerization initiator may be added.

An appropriate quantity of the solvent, a portion of monomer, or a mixture of a potion of monomer with solvent may be charged into the reactor in advance within a range not adversely affecting the molecular weight distribution of the obtained polymer.

The reaction temperature can be freely determined depending on the kind and amount of polymerization initiator, the kind of solvent, the kind and concentration of monomer, and the like. From the point of reaction control, however, a preferable temperature is the level which gives 200 minutes or less of half-life of the polymerization initiator. The reaction temperature is preferably in a range from 30° C. to 120° C., and more preferably from 50° C. to 100° C. The temperature of the reactor during addition of monomer and polymerization initiator can be changed appropriately depending on the progress of the reaction.

The environment of the reactor and of the adding liquid may be, as needed, replaced with inert gas such as nitrogen to remove the oxygen in the reactor and the dissolved oxygen in the liquid.

After the addition of monomer and polymerization initiator, it is preferable to hold the reaction mixture within the above-described temperature range for a specified time to complete the polymerization reaction. The holding time is approximately from 0 to 15 hours.

### [Soil Releasing Agent]

When the polymer of the present invention is used as the soil releasing agent, the above as obtained reaction solution may be used, or the polymer collected by reprecipitation or distilling out the solvent may be used. Alternatively, the polymer of the present invention may be dissolved or dispersed in an aqueous solvent to use as the soil releasing agent.

Furthermore, before using the polymer of the present invention as the soil releasing agent, it is preferable that the total or a part of the amino groups in the polymer be neutralized by acid from the point of adsorption performance to the fibers and of solubility in water. Preferred acids to obtain the acid neutralized compound include: an inorganic acid such as hydrochloric acid, sulfuric acid, nitric acid, and phosphoric acid; and an organic acid having total 1 to 22 carbon atoms, such as acetic acid, propionic acid, formic acid, maleic acid, fumaric acid, citric acid, tartaric acid, adipic acid, sulfamic acid, toluene sulfonate, lactic acid, pyrrolidone-2-carboxylate, succinic acid, glycolic acid, and malic acid.

### [Method for Treating Fiber]

The soil releasing agent according to the present invention gives the effect of soil releasing through the process of: treating the fibers in an aqueous solution containing the soil releasing agent to bring the polymer to adsorb onto the fibers; and then, after the use of the fibers by wearing the clothing, or the like, deterging the fibers in water to desorb or release the polymer together with the soil adhered during the use of the clothing.

The soil releasing agent according to the present invention is particularly useful for hydrophilic fibers. The hydrophilic fibers according to the present invention signify the fibers containing more than 5 percent of water content (20° C., 65 percent RH) in a standard state. The water content in a standard sate is determined by the method specified in JIS L1013 and JIS L1015.

Examples of the hydrophilic fibers are: for natural fibers, seed fiber (cotton, Kapok, and the like), bast fiber (flax, linen, ramie, hemp, jute, and the like), leaf fiber (Manila hemp, Sisal hemp, and the like), coir fiber, rush, straw, wool and hair (wool, mohair, cashmere, camel hair, alpaca, vicuna, angora, and the like), silk (domestic silkworm spun silk yarn, wild silkworm spun silk yarn), and down; and for chemical fibers, cellulose-based fiber (Rayon, Polynosic, Cuprammonium rayon, Acetate fiber, and the like).

According to the present invention, adsorption of polymer onto fibers is preferably done in an aqueous solution adjusted to pH 2 to 9 in view of the adsorption performance to the fibers. Deterging after wearing the clothing or using the fibers attains the detergency effect independent of pH value. It is, however, preferable to deterge the clothing in an aqueous solution adjusted to pH in a range from 9 to 13 from the viewpoint of releasability from the fibers.

Deterging after above-described uses is further preferable to use what is called the detergent. The detergent may contain an arbitrary ingredient commonly added to the detergent, such as a surfactant, a hardness component-entrapping agent, perfume, enzyme, alkali, and bleaching agent.

The soil releasing agent according to the present invention can provide excellent soil releasing effect utilizing the changes in property of primary to tertiary amino group with pH. When a compound containing quaternary ammonium group is used instead of the compound containing primary to tertiary amino group, there occurs no change in property caused by pH so that the excellent soil releasing effect of the present invention cannot be attained.

A preferable use amount of the soil releasing agent according to the present invention is in a range from 0.001 to 10 g, more preferably 0.005 to 5 g, and even more preferably from 0.05 g to 3 g to 1 kg of fibers.

The soil releasing agent according to the present invention can be used by blending with other composition within a range not adversely affecting the performance of the soil releasing agent. Among the other compositions to be blended, preferred one is fiber-treating agent such as detergent, softening agent, and paste. On blending the soil releasing agent, the content thereof is preferably in a range from 0.01 to 50 percent by weight, more preferably from 0.1 to 30 percent by weight, and even more preferably from 0.5 to 20 percent by weight.

### EXAMPLES

The present invention is described in more detail by reference to the Examples below. The Examples are mere illustrative of the present invention and are not intended to limit the present invention.

### Synthesis Example 1

A 35.60 g of dimethylaminoethylmethacrylate, 14.40 g of laurylmethacrylate, and 180.0 g of ethanol were homogeneously mixed. The mixture was poured in a 300 ml glass separable flask, which was then stirred under a nitrogen atmosphere for a specified time. To the mixture, there was added a solution prepared by dissolving 1.41 g of 2,2′-azobis(2,4-dimethylvaleronitrile) (V-65, manufactured by Wako Pure Chemical Industries, Ltd.) in 20.0 g of ethanol. The mixture was heated to around 60° C. By holding the mixture at a temperatures of around 60° C. to 70° C. for 8 hours, the polymerization and aging of the reaction mixture were performed. After adding 100.0 g of ethanol to thus prepared reaction product for dilution, the mixture was cooled to room temperature. The obtained reaction solution was added dropwise to 4000.0 g of ion-exchanged water to reprecipitate and to purify the reaction product. The precipitate was dried to obtain Polymer 1. The Mw, Mn, and Mw/Mn of Polymer 1 were 11000, 2800, and 3.9, respectively, (in water/ethanol=7/3 system; converted to polyethylene oxide). The composition of Polymer 1 analyzed by ¹H-NMR was the same as that of the charged monomer.

### Synthesis Example 2

Polymer 2 was obtained by the same procedure as that of Synthesis Example 1 except that the charged amount of dimethylaminoethylmethacrylate was 36.85 g, the laurylmethacrylate was changed to 13.15 g of styrene, the initial charge of ethanol was 111.7 g, and succeeding charge of 2,2′-azobis (2,4-dimethylvarelonitrile) and ethanol was 0.45 g and 5.0 g, respectively. The Mw, Mn, and Mw/Mn of Polymer 2 were 9200, 5100, and 1.8, respectively, (in dimethylformamide system; converted to polystyrene). The composition of Polymer 2 analyzed by ¹H-NMR was the same as that of the charged monomer.

### Synthesis Example 3

Polymer 3 was obtained by the same procedure as that of Synthesis Example 1 except that dimethylaminoethylmethacrylate was changed to 37.22 g of diethylaminoethylmethacrylate, the charged amount of laurylmethacrylate was 12.78 g, the initial charge of ethanol was 111.7 g, and succeeding charge of 2,2′-azobis (2,4-dimethylvarelonitrile) and ethanol was 0.31 g, and 5.0 g, respectively. The Mw, Mn, and Mw/Mn of Polymer 3 were 28000, 6500, and 4.3, respectively, (in water/ethanol=7/3 system; converted to polyethylene oxide). The composition of Polymer 3 analyzed by ¹H-NMR was the same as that of the charged monomer.

### Synthesis Example 4

Polymer 4 was obtained by the same procedure as that of Synthesis Example 3 except that the initial charge of ethanol was 160.0 g, and succeeding charge of 2,2′-azobis(2,4-dimethylvarelonitrile) and ethanol was 2.49 g and 40.0 g, respectively. The Mw, Mn, and Mw/Mn of Polymer 4 were 9500, 1800, and 5.2, respectively, (in water/ethanol=7/3 system; converted to polyethylene oxide). The composition of Polymer 4 analyzed by ¹H-NMR was the same as that of the charged monomer.

### Synthesis Example 5

The internal atmosphere of 1 L glass separable flask was replaced by nitrogen for a specified time. To the flask, 53.9 g of ethanol was poured, and the content was heated to 78° C. to 80° C. while stirring the content, and was held at the temperature. Separately, 249.19 g of dimethylaminoethylmethacrylate, 100.81 g of laurylmethacrylate, 4.92 g of 2,2′-azobis(2,4-dimethylvarelonitrile), and 130.2 g of ethanol were homogeneously mixed in advance to prepare a solution. The solution was added dropwise into the flask at a constant rate for 3 hours. Then, a solution prepared by dissolving 12.30 g of 2,2′-azobis(2,4-dimethylvarelonitrile) in 49.2 g of ethanol was added dropwise to the mixture in the flask at a constant rate for 5 hours. After completing the dropwise addition, the mixture was held at about 80° C. for 2 hours, thus obtained an ethanol solution of Polymer 5. The Mw, Mn, and Mw/Mn of Polymer 5 were 10000, 3200, and 3.1, respectively, (in water/ethanol=7/3 system; converted to polyethylene oxide). The composition of Polymer 5 analyzed by ¹H-NMR was the same as that of the charged monomer.

### Synthesis Example 6

An ethanol solution of Polymer 6 was obtained by the same procedure as that of Synthesis Example 5 except that the charged amount of dimethylaminoethylmethacrylate was 296.66 g, the charged amount of laurylmethacrylate was 53.34 g, the charged amounts of 2,2′-azobis(2,4-dimethylvarelonitrile) and ethanol, being charged together with the monomer, was 6.25 g and 127.5 g, respectively, and succeedingly charged amount of 2,2′-azobis(2,4-dimethylvarelonitrile) and ethanol was 13.02 g and 52.1 g, respectively. The Mw, Mn, and Mw/Mn of Polymer 6 were 12000, 3200, and 3.7, respectively, (in water/ethanol=7/3 system; converted to polyethylene oxide). The composition of Polymer 6 analyzed by ¹H-NMR was the same as that of the charged monomer.

### Synthesis Example 7

An ethanol solution of Polymer 7 was obtained by the same procedure as that of Synthesis Example 5 except that the charged amount of dimethylaminoethylmethacrylate was 206.67 g, the charged amount of laurylmethacrylate was 143.33 g, the charged amount of 2,2′-azobis(2,4-dimethylvarelonitrile) and ethanol, being charged together with the monomer, was 3.73 g and 132.7 g, respectively, and succeedingly charged amount of 2,2′-azobis(2,4-dimethylvarelonitrile) and ethanol was 11.66 g and 46.6 g, respectively. The Mw, Mn, and Mw/Mn of Polymer 7 were 9100, 3400, and 2.7, respectively, (in water/ethanol=7/3 system; converted to polyethylene oxide). The composition of Polymer 7 analyzed by ¹H-NMR was the same as that of the charged monomer.

### Synthesis Example 8

An ethanol solution of Polymer 8 was obtained by the same procedure as that of Synthesis Example 5 except that the charged amount of diethylaminoethylmethacrylate was 260.55 g instead of dimethylaminoethylmethacrylate, the charged amount of laurylmethacrylate was 89.45 g, the charged amount of 2,2′-azobis(2,4-dimethylvarelonitrile) and ethanol, being charged together with the monomer, was 4.37 g and 135.3 g, respectively, and succeedingly charged amount of 2,2′-azobis(2,4-dimethylvarelonitrile) and ethanol was 10.92 g and 43.7 g, respectively. The Mw, Mn, and Mw/Mn of Polymer 8 were 11000, 3000, and 3.7, respectively, (in water/ethanol=7/3 system; converted to polyethylene oxide). The composition of Polymer 8 analyzed by ¹H-NMR was the same as that of the charged monomer.

### Synthesis Example 9

There were homogeneously mixed 15.00 g of laurylmethacrylate, 35.00 g of methoxypolyethyleneglycolmethacrylate (average polymerization degree of ethylene glycol was 9; NK Ester M-90G, manufactured by Shin Nakamura Chemical Co., Ltd.), 50.0 g of 2-butanone, and 0.50 g of 2,2′-azobis(2,4-dimethylvarelonitrile). The mixture was poured into a 300 mL glass separable flask. The mixture was stirred for a specified time under nitrogen atmosphere. The solution was heated to about 65° C., and was held at the temperature for 6 hours to conduct polymerization and aging. The reaction solution was then dried to obtain Polymer 9. The Mw, Mn, and Mw/Mn of Polymer 9 were 84000, 30000, and 2.8, respectively, (in chloroform system; converted to polystyrene). The composition of Polymer 9 analyzed by ¹H-NMR was the same as that of the charged monomer.

### Synthesis Example 10

There were homogeneously mixed 3.35 g of acrylic acid, 1.65 g of laurylacrylate, 3.3 g of isopropylalcohol, and 0.025 g of 2,2′-azobis(2,4-dimethylvarelonitrile). The mixture was poured into a 300mL glass separable flask. The mixture was heated to about 75° C. under nitrogen atmosphere. To the mixture, a solution prepared by homogeneously mixing 30.15 g of acrylic acid, 14.85 g of laurylacrylate, 29.6 g of isopropylalcohol, and 0.225 g of 2,2′-azobis(2,4-dimethylvarelonitrile) was added dropwise for 3 hours. The mixture was further held at about 75° C. for 0.5 hour to conduct polymerization and aging. To the reaction mixture, there was further added a solution prepared by homogeneously mixing 1.7 g of isopropylalcohol and 0.21 g of 2,2′-azobis(2,4-dimethylvarelonitrile) dropwise for 1 hour, which mixture was further aged at about 70° C. for 1 hour. The reaction solution was then dried to obtain Polymer 10. The Mw, Mn, and Mw/Mn of Polymer 10 were 28000, 4100, and 6.8, respectively, (in dimethylformamide system; converted to polystyrene). The composition of the Polymer 10 analyzed by ¹H-NMR was the same as that of the charged monomer.

### Synthesis Example 11

A 50.00 g of dimethylaminoethylmethacrylate and 11.04 g of ion-exchanged water were homogeneously mixed. The mixture was poured into a 300 mL glass separable flask. The mixture was heated to 50° C. To the mixture under stirring, 48.79 g of diethyl sulfate was added dropwise for 2 hours. After the dropwise addition, the mixture was held at 50° C. for 1 hour under stirring, thus synthesized an aqueous solution of methacryloyloxyethyldimethylethylammoniumethylsulfate (MOEDES).

Polymer 11 was obtained by the same procedure as that of Synthesis Example 1 except that 47.81 g of aqueous solution of above MOEDES was charged instead of dimethylaminoethylmethacrylate, the charged amount of laurylmethacrylate was 6.30 g, the initial charge of ethanol was 175.9 g, the charge of 2,2′-azobis(2,4-dimethylvarelonitrile) was 1.64 g, and the reprecipitation purification was conducted by hexane. The Mw, Mn, and Mw/Mn of Polymer 11 were 33000, 1900, and 17, respectively, (in water/ethanol=7/3 system; converted to polyethylene oxide) The composition of Polymer 11 analyzed by ¹H-NMR was the same as that of the charged monomer.

The compositions of Polymers 1 to 11, synthesized in Synthesis Examples 1 to 11, are summarized in Table 1. The abbreviations in the table signify the following.
DMAEMA: dimethylaminoethylmethacrylate
DEAEMA: diethylaminoethylmethacrylate
LMA: laurylmethacrylate
LA: laurylacrylate
St: styrene
PEG(9) MA: methoxypolyethyleneglycolmethacrylate (the average polymerization degree of ethylene glycol is 9)
AA: acrylic acid
MOEDES: methacryloyloxyethyldimethylethylammoniumethylsulfate

TABLE 1

| | | | Polymer | | | | | | | | | | |
|---|---|---|---|---|---|---|---|---|---|---|---|---|---|
| | | | 1 | 2 | 3 | 4 | 5 | 6 | 7 | 8 | 9 | 10 | 11 |
| Monomer | Monomer | DMAEMA | 71 | 74 | — | — | 71 | 85 | 59 | — | — | — | — |
| composition | (A) | DEAEMA | — | — | 74 | 74 | — | — | — | 74 | — | — | — |
| (percent by | Monomer | LMA | 29 | — | 26 | 26 | 29 | 15 | 41 | 26 | 70 | — | 13 |
| weight) | (B) | LA | — | — | — | — | — | — | — | — | — | 33 | — |
| | | St | — | 26 | — | — | — | — | — | — | — | — | — |
| | Monomer | PEG(9)MA | — | — | — | — | — | — | — | — | 30 | — | — |
| | (C) | AA | — | — | — | — | — | — | — | — | — | 67 | — |
| | | MOEDES | — | — | — | — | — | — | — | — | — | — | 87 |

| | | | | | | | | | | | |
|---|---|---|---|---|---|---|---|---|---|---|---|
| Weight average molecular weight | 1.1 | 0.92 | 2.8 | 0.95 | 1.0 | 1.2 | 0.91 | 1.1 | 8.4 | 2.8 | 3.3 |
| (ten thousand) | | | | | | | | | | | |
| Dispersion ratio (Mw/Mn) | 3.9 | 1.8 | 4.3 | 5.2 | 3.1 | 3.7 | 2.7 | 3.7 | 2.8 | 6.8 | 17 |

### Examples 1 to 8 and Comparative Examples 1 to 4

The Polymers 1 to 11 obtained in the Synthesis Examples were used as the soil releasing agent to treat fibers by the following-described method to evaluate the effect of soil releasing. The result is given in Table 2.

### <Method for Evaluating the Effect of Soil Releasing>

(1) Treatment of Fiber

A treatment liquid was prepared by adding 0.01 g of each polymer neutralized by hydrochloric acid, (for the case of solution; as polymer content), to 500 mL of hard water (4° DH, calcium/magnesium=7/3) at 20° C. The pH of the treatment solution was in a range from 6.5 to 7.5. To the treatment solution, 5 g of cotton broadcloth (manufactured by Senshokushizai Kabushikikaisha Tanigashira Shoten) in cut-pieces (6×6 cm) was charged. The mixture was stirred for 5 minutes using a Terg-O-Tometer at 80 rpm. Then, the mixture was dewatered in a two-tank washing machine (PS-H35L, manufactured by Hitachi, Ltd.) for 1 minute, followed by natural drying.

(2) Preparation of Model Sebum Soil

A model sebum soil was prepared by adding 0.01 g of pigment (oil orange SS, manufactured by Tokyo Chemical Industry Co., Ltd.) to 10 g of a sebum component mixture (oleic acid/triolein/squalene=45/40/15 by weight ratio, which were manufactured by Wako Pure Chemical Industries, Ltd.).

(3) Preparation of Cloth Polluted by Model Sebum

To a sheet of cotton broadcloth (6×6 cm) which was treated by the polymer in accordance with the above method, 80 mg of the model sebum soil was added dropwise to prepare the polluted cloth.

(4) Deterging the Fiber

A 150 mg of nonionic a surfactant(Emulgen 108, manufactured by Kao Corporation) and 150 mg of sodium carbonate (manufactured by Wako Pure Chemical Industry Co., Ltd.) were added to 1 L of hard water (4° DH, calcium/magnesium=7/3) at 20° C. To thus prepared solution, the above-prepared polluted cloth was immersed. Using a Terg-O-Tometer, the cloth was deterged for 10 minutes under stirring at 80 rpm.

(5) Calculation of Detergency

The reflectance (at 460 nm) of each of the non-treated cloth, the polluted cloth before deterging, and the polluted cloth after deterging was determined by a calorimeter (ND-300A, manufactured by Nippon Denshoku Industries Co., Ltd.). The detergency D (percent) was calculated by the following formula. Thus derived detergency D was adopted as the index of the effect of soil releasing.

D(percent)=[(L₂−L₁)/(L₀−L₁)]×100

where, L₀ is the reflectance of the non-treated cloth, L₁ is the reflectance of the polluted cloth before deterging, and L₂ is the reflectance of the polluted cloth after deterging.

TABLE 2

| | | Detergency D |
|---|---|---|
| | Soil releasing agent | (%) |
| Example | | |
| 1 | Polymer 1 | 52 |
| 2 | Polymer 2 | 54 |
| 3 | Polymer 3 | 53 |
| 4 | Polymer 4 | 58 |
| 5 | Polymer 5 | 54 |
| 6 | Polymer 6 | 55 |
| 7 | Polymer 7 | 53 |
| 8 | Polymer 8 | 54 |
| Comparative | | |
| Example | | |
| 1 | Polymer 9 | 42 |
| 2 | Polymer 10 | 42 |
| 3 | Polymer 11 | 44 |
| 4 | Treated only with water | 42 |

1. A soil releasing agent for fiber, comprising a polymer having a weight-average molecular weight in a range from 2,000 to 30,000, and comprising a structural unit (A) and a structural unit (B), the content of the structural unit (A) in the polymer being 50 to 99 percent by weight, and the content of the structural unit (B) in the polymer being 1 to 50 percent by weight:
(A) a structural unit derived from a monomer which has an unsaturated bond and at least one amino group selected from a primary amino group, a secondary amino group and a tertiary amino group;
(B) a structural unit derived from a monomer which has an unsaturated bond and at least one hydrophobic group selected from the group consisting of an alkyl or alkenyl group, each having 4 to 22 carbon atoms, being straight, branched or cyclic, an arylalkyl group having 1 to 22 carbon atoms in the alkyl group and an aryl group, and which monomer has no primary to tertiary amino group.

2. The soil releasing agent for fiber according to claim 1, wherein the structural unit (A) is a unit derived from at least one monomer selected from the group consisting of a (meth)acrylate compound, a (meth)acrylamide compound, a styrene compound and a diallyl compound, each having a primary to tertiary amino group.

3. The soil releasing agent for fiber according to claim 1 or claim 2, wherein the structural unit (B) is a unit derived from at least one monomer selected from the group consisting of a (meth)acrylate, a (meth)acrylamide, a vinyl ester, a vinyl ether and a styrene compound, each having the above hydrophobic group.

4. The soil releasing agent for fiber according to claim 1, wherein the dispersion ratio [(weight average molecular weight)/(number-average molecular weight)] of the polymer is in a range from 1.0 to 6.0.

5. The soil releasing agent for fiber according to claim 1, wherein the polymer is prepared by polymerization conducted by continuously or intermittently adding a monomer and a polymerization initiator to the reaction system.

6. A method for treating fiber, comprising the step of treating a fiber in an aqueous solution which comprises the soil releasing agent for fiber according to claim 1 and is adjusted to pH 2 to 9.

7. The method for treating fiber according to claim 6, wherein the fiber is a hydrophilic fiber.

8. Use of the polymer according to claim 1 as a soil releasing agent for fiber.
